(19) United States
(12) Patent Application Publication
(10) Pub. No.: US 2007/0006501 A1
(43) Pub. Date: Jan. 11, 2007

(54) Message mat

(76) Inventors: Carol A. Pierce, Clinton, MD (US); Stephanie D. Pierce, Clinton, MD (US); Dionne T. Shaw, Upper Marlboro, MD (US); Keisha L. Pinkney, Upper Marlboro, MD (US); Tanisha L. Welch, Upper Marlboro, MD (US)

Correspondence Address: Carol A. Pierce, 8305 Deborah Street, Clinton, MD, 20735, US

(21) Appl. No.: 11/165,355

(22) Filed: Jun. 24, 2005

(51) Int. Cl. G09F 7/02

(52) U.S. Cl. 40/618

(57) ABSTRACT

A message bearing welcome mat where the messages are either electronic or removable. The messages can be changed to reflect the season, the ideals of the homeowner or a message designed by the homeowner for that day or a particular person. Music or tunes greet the visitor as he or she approaches the door wherein a fragrance is propelled into to atmosphere to set a tranquil mood. A proximity sensor senses the approach of the visitor and causes the electronic message to display, the music to begin and the fragrance to be sprayed into the atmosphere.

### BACKGROUND OF THE INVENTION

1. Field of the Invention

The invention relates generally to bathroom or doormats. More specifically, the invention relates to a message bearing welcome mats.

2. Description of Related Art

Welcome mats are used to greet arriving guests in most homes today. The words “hello” or “welcome” are often printed or somehow displayed on the mats. The purpose is to make the visitor feel welcome. An additional purpose is to give the guest or visitors means by which to wipe their shoes to dislodge dirt and grime before entering the house. Although the traditional welcome mat has served a very useful purpose, in today's time of interactive multimedia, visual and auditory sensations and even aroma theropy, the traditional welcome mat seems quaint and outdated. People have grown tired of the ordinary and almost expect the extraordinary. In other words, society has adapted to a world where information and ideas are presented in many different ways and through many different vehicles. This is true in many facets of life from the advances in the telephone industry, computers, televisions and even everyday household appliances. However, there is one market or channel of goods that has for the most part not been a party to the advances in technology and related fields. In the vast majority of homes the simple welcome mat still greets newly arriving guests. Since we live in an information filled society that places a high premium on knowledge, information and message promulgation, an advanced welcome mat utilizing the latest in technology is greatly needed. Homeowners would love to have a welcome mat that not only greets visitors with a personalized message but also plays customized music or tunes while dispensing perfumes. Such a mat could play music or messages that are based on the season, on the political/social/moral views of the owner and spray calming aromas into the atmosphere. The instant invention is such a device.

### SUMMARY OF THE INVENTION

The invention relates to a message bearing welcome mat. The messages are either electronic or removable placed on the mat. The messages can be changed to reflect the season, the ideals of the homeowner or a message designed by the homeowner for that day or a particular person. Music or tunes greet the visitor as he or she approaches the door wherein a fragrance is propelled into to atmosphere to set a tranquil mood. A proximity sensor senses the approach of the visitor and causes the electronic message to display, the music to begin and the fragrance to be sprayed into the atmosphere.

There is, therefore, a need for a message mat that conveys the ideals of the owner.

Accordingly, it is a principal object of the invention to provide a message mat that has removable messages.

Still another object of the invention is to provide a message mat that uses electronic messages.

It is again an object of the invention to provide a message mat that uses music or tunes.

Another object of the invention is to provide a message mat that sprays fragrances into the atmosphere.

Yet another object of the invention is to provide a message mat that uses a proximity sensor.

Again, other object of the invention is to incorporate a memory card in the message mat.

It is yet another object of the invention to provide a message mat with microprocessor.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is a perspective view of the preferred embodiment.

FIG. 2 is a perspective view of the preferred embodiment

Similar reference characters denote corresponding features consistently throughout the attached drawings.

### DETAILED DESCRIPTION OF THE PREFERRED EMBODIMENTS

The invention relates to a message bearing welcome mat. The messages are either electronic or removable placed on the mat. The messages can be changed to reflect the season, the ideals of the homeowner or a message designed by the homeowner for that day or a particular person. Music or tunes greet the visitor as he or she approaches the door wherein a fragrance is propelled into to atmosphere to set a tranquil mood. A proximity sensor senses the approach of the visitor and causes the electronic message to display, the music to begin and the fragrance to be sprayed into the atmosphere.

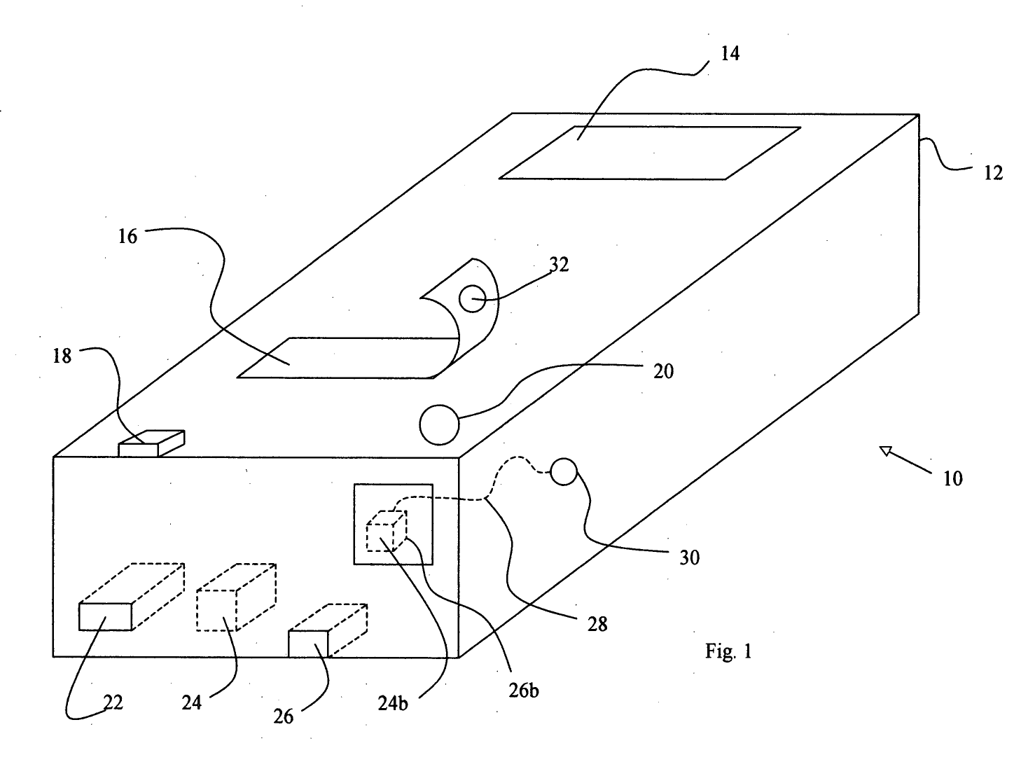

Turning now to the drawings, in FIG. 1 a message display mat 10 is shown having a mat 12, an electronic display 14, a removable display 16, a magnet 32 attached to the underside of removable display 16 to attach the display 16 to the mat 12. A microprocessor 24 or computer sends music or sound to a speaker 20 and causes the fragrance dispenser 26b to dispense fragrance out of the spray nozzle 30 via tubing 28. A proximity sensor 18 detects the presence of a visitor, sends a signal to the micro-processor 24 or computer which in turn activates the electronic display 14, sends sound to the speaker 20 and/or activates the fragrance dispenser 26b.

A memory card 26 allows the user to program the microprocessor 24 of the display mat 10 to display certain messages on the electronic display based on the seasons, or on political/moral/religious views of the owner, or on any criteria the user wishes. The ideals displayed in the instant invention focus mostly on Christian beliefs and ideals. Messages extolling the virtues and teachings of Christ, messages saying “be blessed”, messages listing certain biblical references and messages pointing to internet web pages are a few of the messages (both electronic and removable) displayed. Likewise the music or sounds and fragrances are designed to evoke a Godly response from the recipient. The music or sounds could be musical recordings including vocals and instrumentals, the spoken word, and sounds found in a typical production music library. The purpose or message of the message mat 10 is to share the teachings and beliefs of Christians to others.

The memory card 26 can be removed from mat 12 and placed in a desktop computer wherein the user can load certain messages (both textural and graphical (i.e., pictures)) or music or sounds. Via the desktop computer the user can also program how the display mat 10 interacts with the environment. For instance, via the desktop the user can dictate ifjust the message is displayed or if the display includes music and/or a fragrance. The user can also determine the order of messages to be displayed. Once the memory card 26 has been programmed, the user places it back into the mat 12 wherein it interacts with the microprocessor 24 and re-programs the microprocessor 24.

Different fragrance dispensers 26b can be placed within mat 12 via door 24b. A battery 22 supplies power to the microprocessor 24.

The proximity sensor 18 can detect from which direction the visitor is approaching which allows the display mat to show the sign “welcome” or “goodbye, have a nice day” or have a voice speak “welcome” or “have a nice day”. This, of course, is programmed into the memory card 26 by the user.

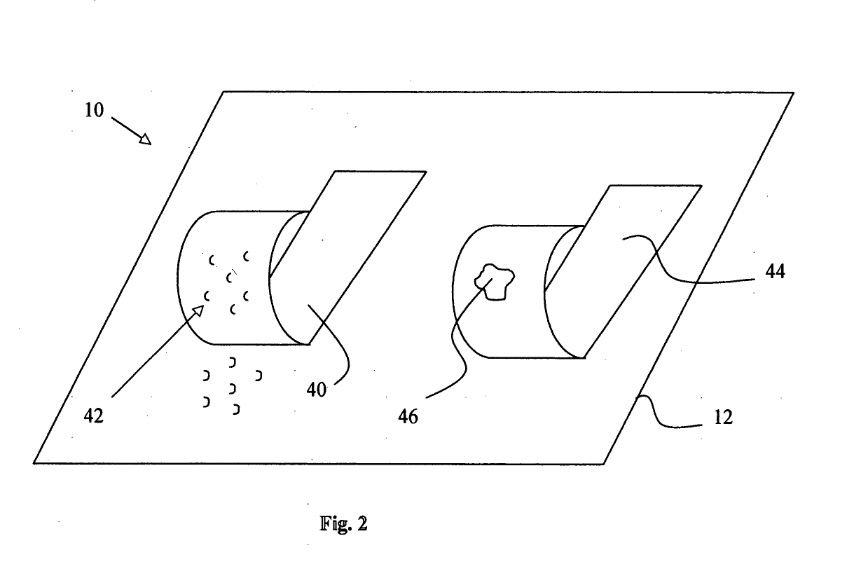

FIG. 2 shows a message display mat 10 having a mat 12 with two removable displays 40, 44. The first display 40 is attached to the mat 12 via hook and loop type fasteners 42. The second removable display 44 is attached to the mat 12 via an adhesive 46. The removable displays can be made of plastic, vinyl, rubber, wood or any appropriate material.

It is to be understood that the present invention is not limited to the sole embodiment described above, but encompasses any and all embodiments within the scope of the following claims.

We claim:

1. A message mat for conveying particular ideals comprising:
display means located on the mat for displaying images representing the particular ideals.

2. The message mat according to claim 1 wherein said display means are switchable between multiple images.

3. The message mat according to claim 2 wherein said display means are removable.

4. The message mat according to claim 3 wherein said display means comprises Christian images.

5. The message mat according to claim 4 wherein said display means are electronic.

6. The message mat according to claim 5 wherein said display means directs the viewer to an internet site.

7. The message mat according to claim 6 wherein the message mat has means for playing sounds.

8. The message mat according to claim 7 wherein the message mat has means for emitting fragrances.

9. The message mat according to claim 8 wherein said message mat has a proximity sensor.

10. The message mat according to claim 9 having a switchable electronic display means wherein the message mat further comprises a control device for controlling the switchable electronic display means, the proximity sensor, the means for emitting fragrances and the means for playing sounds.

11. The message mat according to claim 10 wherein said display means are attached to the message mat via hook and loop type fasteners.

12. The message mat according to claim 10 wherein said display means are attached to the message mat via adhesives.

13. The message mat according to claim 10 wherein said display means are attached to the message mat via magnets.

14. A message mat for conveying particular ideals comprising:
display means located on the mat for displaying Christian images and wherein said display means are removable and wherein said display means are switchable between different Christian images.

15. The message mat according to claim 14 wherein said display means are electronic.

16. The message mat according to claim 15 wherein the display means displays an internet site.

17. The message mat according to claim 16 wherein said display means has means for playing sounds, means for emitting fragrances and a proximity sensor.

18. The message mat according to claim 17 wherein said proximity sensor controls said means for emitting fragrances, said means for playing sounds and wherein the message mat further comprises a control device for controlling the switchable electronic display means, the proximity sensor, the means for emitting fragrances and the means for playing sounds.

19. The message mat according to claim 18 wherein said display means are attached to the message mat via attachment means.
